(19) United States
(12) Patent Application Publication
(10) Pub. No.: US 2025/0023257 A1
(43) Pub. Date: Jan. 16, 2025

(54) DUAL-POLARIZED DUAL-BAND USER EQUIPMENT ANTENNA ARRAY

(71) Applicant: Samsung Electronics Co., Ltd., Suwon-si (KR)

(72) Inventors: Jiantong Li, McKinney, TX (US); Sung-Chul Park, Seoul (KR); Jianhua Mo, Allen, TX (US); Aditya Dave, Plano, TX (US); Young Han Nam, Plano, TX (US); Won Suk Choi, McKinney, TX (US); Gang Xu, Allen, TX (US)

(21) Appl. No.: 18/444,439

(22) Filed: Feb. 16, 2024

Related U.S. Application Data
(60) Provisional application No. 63/526,889, filed on Jul. 14, 2023.

(51) Int. Cl. H01Q 25/00; H01Q 1/38

(52) U.S. Cl. CPC H01Q 25/001; H01Q 1/38

(57) ABSTRACT

An apparatus includes a first, second, and third substrates. The first substrate includes a first antenna element supporting a first frequency band and a second frequency band higher than the first frequency band. The first substrate includes a first dielectric material having a first dielectric constant. The second substrate includes a second antenna element supporting the first frequency band and the second frequency band. The second substrate includes the first dielectric material. The third substrate is disposed between the first substrate and the second substrate and includes a third antenna element supporting the second frequency band. The third substrate includes a second dielectric material having a second dielectric constant lower than a first dielectric constant. The first and second antenna elements form a first beam in the first frequency band. The first, second, and third antenna elements form a second beam in the second frequency band.

### CROSS-REFERENCE TO RELATED APPLICATION AND PRIORITY CLAIM

This application claims priority under 35 U.S.C. § 119(e) to U.S. Provisional Patent Application No. 63/526,889 filed on Jul. 14, 2023, which is hereby incorporated by reference in its entirety.

### TECHNICAL FIELD

This disclosure relates generally to multiple-input multiple-output (MIMO) antenna array devices and processes. More specifically, this disclosure relates to a dual-polarized dual-band user equipment (UE) antenna array.

### BACKGROUND

The growing demand for various wireless applications such as wearables, virtual reality (VR) and automation, results in severe data traffic issues at commonly used bands, which necessitates the requirement of higher data rates. It is estimated that machines, especially high-resolution media and extended reality (XR), will be the dominant consumer type of future communication systems. The MIMO technology is one option to increase channel efficiency within the same spectrum. A massive MIMO configuration is utilized for 5G/6G base stations to further improve the channel capacity by using a large number of antennas. With an antenna array of multiple elements, a narrower beam is formed, which can be spatial focused. Further, beamforming techniques are used to provide an interference-free and high-capacity link to each user, thus increasing the spatial resolution without increasing inter-cell complexity.

### SUMMARY

This disclosure provides a dual-polarized dual-band UE antenna array.

In a first embodiment, an apparatus includes a first substrate, a second substrate, and a third substrate. The first substrate includes a first antenna element configured to support a first frequency band and a second frequency band higher than the first frequency band. The first substrate includes a first dielectric material having a first dielectric constant. The second substrate includes a second antenna element configured to support the first frequency band and the second frequency band. The second substrate includes the first dielectric material. The third substrate is disposed between the first substrate and the second substrate and includes a third antenna element configured to support the second frequency band. The third substrate includes a second dielectric material having a second dielectric constant lower than the first dielectric constant. The first antenna element and the second antenna element are configured to form a first beam in the first frequency band. The first antenna element, the second antenna element, and the third antenna element are configured to form a second beam in the second frequency band.

In a second embodiment, an electronic device includes a multiple input multiple output (MIMO) antenna, transmit (TX) processing circuitry, and receive (RX) processing circuitry. The MIMO antenna includes a first substrate, a second substrate, and a third substrate. The first substrate includes a first antenna element configured to support a first frequency band and a second frequency band higher than the first frequency band. The first substrate includes a first dielectric material having a first dielectric constant. The second substrate includes a second antenna element configured to support the first frequency band and the second frequency band. The second substrate includes the first dielectric material. The third substrate is disposed between the first substrate and the second substrate and includes a third antenna element configured to support the second frequency band. The third substrate includes a second dielectric material having a second dielectric constant lower than the first dielectric constant. The first antenna element and the second antenna element are configured to form a first beam in the first frequency band. The first antenna element, the second antenna element, and the third antenna element are configured to form a second beam in the second frequency band. The TX processing circuitry is configured to provide signals to the first antenna element, the second antenna element, and the third antenna element. The RX processing circuitry is configured to receive signals from the first antenna element, the second antenna element, and the third antenna element.

In a third embodiment, a method includes supporting a first frequency band and a second frequency band higher than the first frequency band using a first antenna element included in a first substrate including a first dielectric material having a first dielectric constant. The method also includes supporting the first frequency band and the second frequency band using a second antenna element included in a second substrate including the first dielectric material. The method further includes supporting the second frequency band using a third antenna element included in a third substrate disposed between the first substrate and the second substrate, the third substrate including a second dielectric material having a second dielectric constant lower than the first dielectric constant. In addition, the method includes forming a first beam in the first frequency band using the first and the second antenna element. The method also includes forming a second beam in the second frequency band using the first antenna element, the second antenna element, and the third antenna element.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIGS. 2 and 3 illustrate example electronic devices in accordance with an embodiment of this disclosure;

FIGS. 4A and 4B illustrate an example mmW antenna array on an electronic device in accordance with this disclosure;

FIGS. 5A through 5G illustrate an example antenna array in accordance with this disclosure;

FIG. 6 illustrates an example flowchart of a design of the antenna array in accordance with this disclosure;

FIGS. 7A through 7D illustrate an example antenna array in accordance with this disclosure;

FIG. 8 illustrates an example antenna array in accordance with this disclosure;

FIG. 9 illustrates an example antenna array in accordance with this disclosure;

FIG. 10 illustrates an example antenna array module in accordance with this disclosure;

FIGS. 11A and 11B illustrate an example antenna array module in accordance with this disclosure;

FIG. 12 illustrates an example antenna array with a slitted patch in accordance with this disclosure;

FIG. 13 illustrates an example antenna array mounted on a metal housing in accordance with this disclosure;

FIG. 14 illustrates an example beamforming pattern in accordance with this disclosure;

FIGS. 15A and 15B illustrate an example antenna array in accordance with this disclosure;

FIGS. 16A and 16B illustrate example beamforming patterns in accordance with this disclosure;

FIG. 17 illustrates an example antenna array positioned in a recess of a housing in accordance with this disclosure;

FIG. 18 illustrates an example electronic device with an antenna array horizontally mounted in accordance with this disclosure; and

FIG. 19 illustrates an example method for a dual-polarized dual-band UE antenna array according to this disclosure.

### DETAILED DESCRIPTION

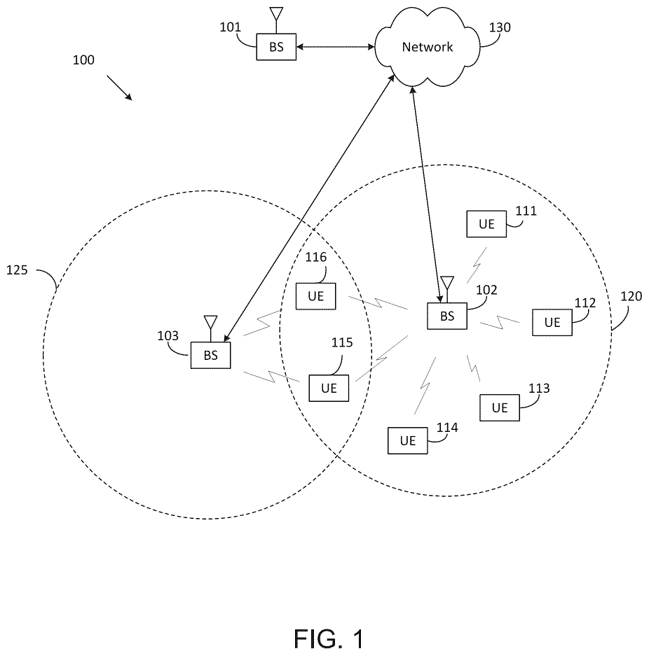

FIGS. 1 through 19, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

Wi-Fi, most phones, and most applications are on a first frequency range (FR1) band. As more user case or applications are developed, such as VR, AR, medical devices, robotic applications, etc. the network can experience severe data traffic issues. Different candidate frequency ranges can help reduce the traffic issues and satisfy data requirements. A traditional frequency band, such as FR1, is 3.5 gigahertz and FR2 refers to 5G application or a millimeter wave band. FR2 can be referred to as the millimeter wave band because the wavelength becomes smaller as the frequency increases. The FR 2 band can correspond to 28 gigahertz or 39 gigahertz. The FR 2 band is almost ten times gigahertz of the FR1 band. The next FR band can extend to 140 gigahertz. In the United States, the FR3 is selected as 13 gigahertz, which is between the FR1 and FR2 bands. The FR3 band can also be referred to as the mid band.

Compared with current millimeter-wave band (mmW band), the FR3 band (7 GHz-24 GHz, also called upper middle band band) is capable of offering higher coverage and capacity for multiple users at the same time. Though the FR3 band utilizes a lower frequency than 28 GHz of 5G band, it employs a larger antenna array with more than 1000 antenna elements, which targets at (1) high spectral efficiency, (2) extended coverage, and (3) more layers of spatial multiplexing of both single-user MIMO (SU-MIMO) and multi-user MIMO (MU-MIMO).

There are several key challenges to expand the capability of supporting another possible 6G band. One challenge is space limitation due to surrounding components. Adding separate antennas for a new band takes significant space inside a phone. Another challenge is due to profile limitations based on phone thickness. For example, a phone thickness can be approximately 7.6 mm and the available thickness for antennas is reduced to 5.5 mm, which is 0.51λ₀ at 28 GHz and 0.24λ₀ at 13 GHz. Also, beamforming gain requirements can be a challenge. For example, a 13-GHz band endures 11.4 dB more path loss compared with a 3.5-GHz band.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

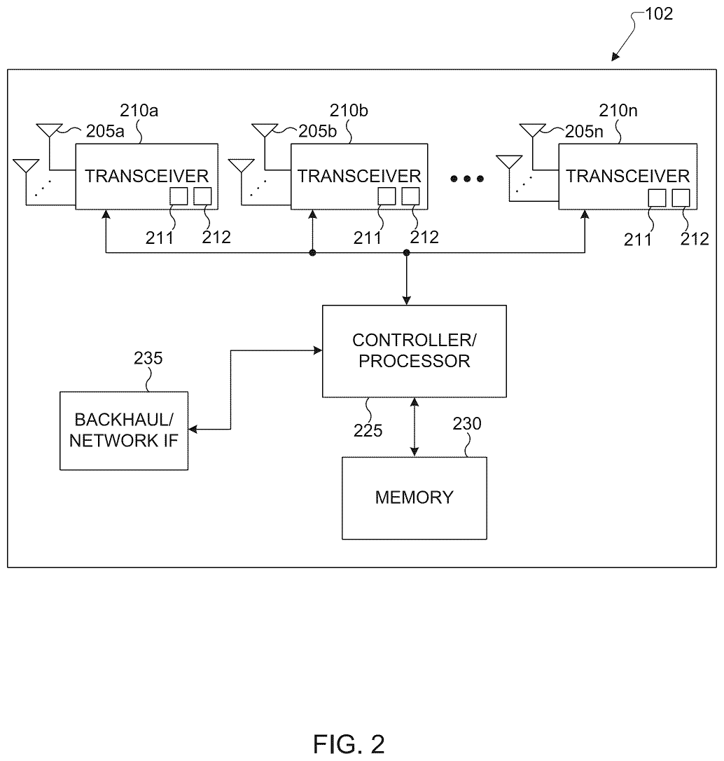

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry 211 in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry 212 in the transceivers 210a-210n and/or controller/processor 225 receives analog or digital data (such as voice data, web data, e-mail, or interactive video game data) from the controller/processor 225. The TX processing circuitry 212 encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

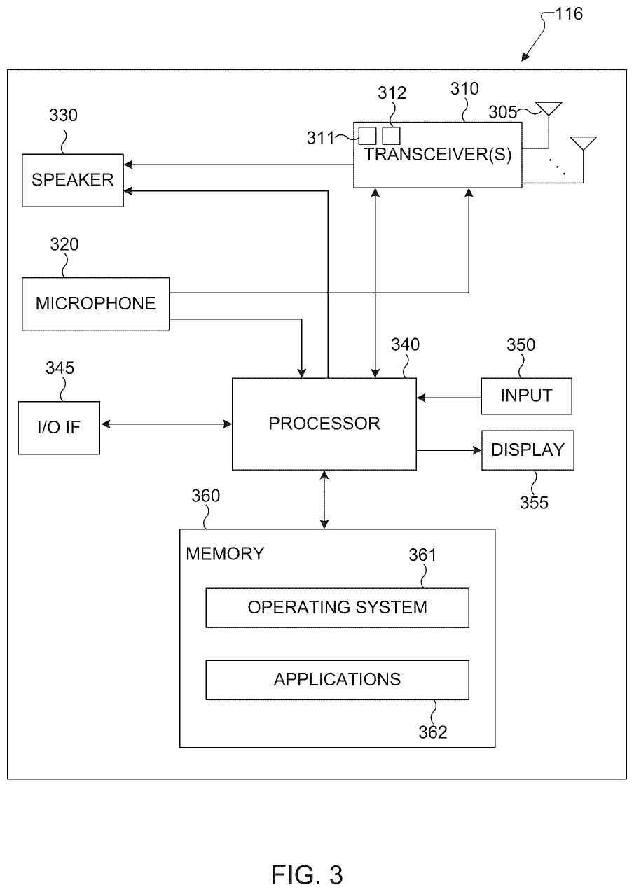

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry 311 in the transceiver(s) 310 and/or processor 340, which generates a processed baseband signal by filtering, decoding, and/or digitizing the baseband or IF signal. The RX processing circuitry 311 sends the processed baseband signal to the speaker 330 (such as for voice data) or is processed by the processor 340 (such as for web browsing data).

TX processing circuitry 312 in the transceiver(s) 310 and/or processor 340 receives analog or digital voice data from the microphone 320 or other outgoing baseband data (such as web data, e-mail, or interactive video game data) from the processor 340. The TX processing circuitry 312 encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

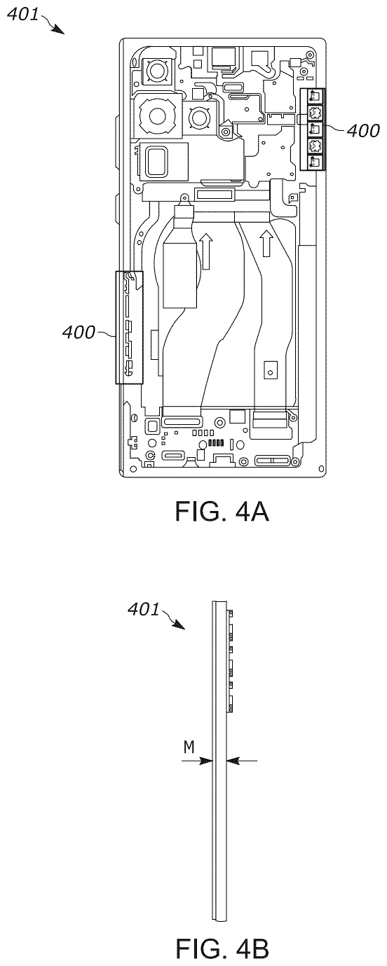

FIGS. 4A and 4B illustrate an example antenna array 400 on an electronic device 401 in accordance with this disclosure. The embodiments of the antenna array 400 illustrated in FIGS. 4A and 4B are for illustration only. FIGS. 4A and 4B do not limit the scope of this disclosure to any particular implementation of an electronic device.

As shown in FIGS. 4A and 4B, the electronic device 401 can include multiple antenna arrays 400. One antenna array 400 can face the side member, while another antenna array 400 can face the rear plate. As shown in Table 1, FR3 antenna arrays are supposed to maintain 1) multiple antennas facing both back and edge; 2) beamforming and spatial multiplexing; 3) dual polarization; 4) high boresight gain; and 5) low cost and easy fabrication.

TABLE 1

| | | | |
|---|---|---|---|
| Antennas on phone | FR1 (3.5 GHz) | FR2 (28 GHz) | FR3 (13 GHz) |
| Antenna type | PIFA antennas | 2 patch arrays | 2 patch arrays |
| Location | Back, 4 Edges | Back, 1 Edge | Back, 1 Edge |
| Operation | No beamforming | Beamforming | Beamforming + |
| | Spatial multiplexing | Module switching | Spatial multiplexing |
| Available phone | 0.06λ₀ at 3.5 GHz | 0.51λ₀ at 28 GHz | 0.24λ₀ at 13 GHz |
| thickness of 5.5 mm | | | |

Because the frequency is low for an FR1 antenna, that means the wavelength is large. A planar inverted-F antenna (PIFA) can be selected as a simple FR1 antenna and can be used on the back or edges of a cell phone due to the length and frequency of the PIFA. The sizes of the antennas increase for the FR2 band and usually require working as an array. For example, a 1×5 antenna array can be used for the FR2 band. This allows for a smaller size of each antenna in the array and can be placed along with the antenna operating in the FR1 band.

Antenna arrays can also be used because post-5G or potential 6G can perform beam forming and other advanced functionalities. The antenna arrays can be used as a group of antenna elements to support the advanced communication requirements from 5G or 6G.

As mentioned before, the antenna must fit in a phone with the size requirements for the thickness of the phone, such as 7.6 mm. However, the phone may have a case or have some plastic material to separate components from metal and space for other components, which reduces the available thickness further. For example, when the total thickness is 7.6 mm, the available phone thickness for the antenna may be 5.5 mm or less. For a thickness of 5.5 mm, the fixed height of the wavelengths may be approximately 0.5 wavelengths, which is almost traditional wavelength of 0.5 wavelengths or half wavelengths. But this height for a different frequency for the FR3 band would only be 0.24 wavelengths, which is half because the frequency is almost half of the FR2 band. The wavelength is suitable for FR2, but the FR3 band will have a very small area, which can influence the overall performance.

Although FIGS. 4A and 4B illustrate an example antenna array 400 on an electronic device 401, various changes may be made to FIGS. 4A and 4B. For example, the number and placement of various components of the antenna array 400 can vary as needed or desired. In addition, the antenna array 400 may be used in any other suitable telecommunications process and is not limited to the specific processes described above.

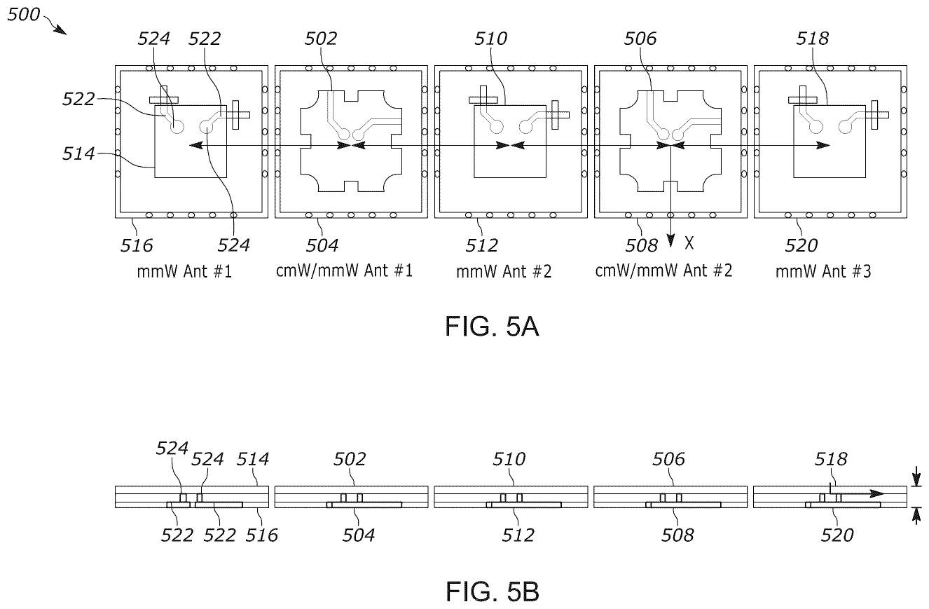

FIGS. 5A through 5G illustrate an example antenna array 500 in accordance with this disclosure. The embodiments of the antenna array 500 illustrated in FIGS. 5A through 5G are for illustration only. FIGS. 5A through 5G do not limit the scope of this disclosure to any particular implementation of an electronic device. While the following illustrates a design of an antenna array 500 with five antenna elements, the design can be extended to other antenna element sizes, e.g., a four antenna element array, a six antenna element array, a seven antenna element array, etc.

As shown in FIGS. 5A through 5G, an antenna array 500 can include multiple antenna elements arranged in a row. The antenna array 500 can include alternating antenna elements that support different frequency bands. A patch antenna and antenna element design assume 0.5λ₀ as antenna ground size, which could fully capture the radiating power of two radiating edges. However, the available phone thickness for an antenna is around 5.5 mm, or around 0.24λ₀ at 13 GHz. As the patch antenna size is dependent on substrate material, the use of high dielectric material will decrease the antenna size. A high dielectric material can be used to reduce the patch antenna size and antenna element size.

The capacitive coupling is utilized with two probing circular patches to support 45-deg and 135-deg dual polarization. A feeding line 522 is located on a 5-mil substrate with dielectric constant of 3. Two 10 mil dielectric layers (dielectric constant is 11.2) can be used to locate capacitive probing circular patch 524 and radiating patch. The combined layer stack-up of low/high dielectric constants improves the radiation efficiency and reduces the transition loss simultaneously. Used as half guide wavelength of stack-up, the patch size is optimized as 0.24λ₀ and 0.03λ₀ as total thickness. A low dielectric material is used for 28 GHz antennas and high dielectric constant for 13 GHz.

The antenna array 500 can include a first antenna element 502 included in a first substrate 504. The first antenna element 502 can support a first frequency band, such as a frequency band between 7 GHz and 24 GHz, and a second frequency band, such as a frequency band higher than 24 GHz. The first substrate 504 can include a first dielectric material.

The antenna array 500 can include a second antenna element 506 included in a second substrate 508. The second antenna element 506 can support the first frequency band and the second frequency band, similarly to the first antenna element 502. The second substrate 508 can include a first dielectric material, similarly to the first substrate 504.

The antenna array 500 can include a third antenna element 510 included in a third substrate 512. The third antenna element 510 can support the second frequency band but, in some cases, may not support the first frequency band. The third substrate 512 can include a second dielectric material having a second dielectric constant lower than the first dielectric constant.

The first antenna element 502 and the second antenna element 506 can form a first beam in the first frequency. The first antenna element 502, the second antenna element 506, and the third antenna element 510 can form a second beam in the second frequency. The antenna array 500 can include additional third antenna elements 510 on the other side of the first antenna element 502 and the other side of the second antenna element 506.

The antenna array 500 can include a fourth antenna element 514 included in a fourth substrate 516. The fourth antenna element 514 can support the second frequency band but, in some cases, may not support the first frequency band. The fourth substrate 516 can include the second dielectric material having the second dielectric constant.

The antenna array 500 can include a fifth antenna element 518 included in a fifth substrate 520. The fifth antenna element 518 can support the second frequency band but, in some cases, may not support the first frequency band. The fifth substrate 520 can include the second dielectric material having the second dielectric constant.

The antenna array 500 can support both the FR2 band and the FR3 band according to the 6G requirements. In order for the first and second antenna elements 502 and 506 to support both the first frequency band and the second frequency band and remain within the specified measurements for the antenna array inside of the electronic device, edge and/or corners portions of the antenna element can be removed, or a slot can be added.

In certain embodiments, high order harmonics can be used with the antenna. For example, a 3 GHz antenna also has weak signals at the 6 GHz, 9 GHz, and 12 GHz. A network operating at a frequency will have some harmonic at two times the frequency, three times the frequency, four times the frequency, etc. In this case, the double frequency is utilized because 28 GHz is a little over double of 13 GHz, creating a half relationship. Optimizing the second harmonic increase efforts to support the frequency band. This allows for easier tuning of the lower frequency and higher frequency due to using the wavelength as a parameter.

For the dual band operation, a cm wavelength (cmW) antenna element can operate in the 13 GHz frequency range and an mm wavelength (mmW) antenna element can operate in the 28 GHz frequency range. For cmW antenna operation, the first antenna element 502 and the second antenna element 506 can be active in 0.498λ₀ at 13 GHz, which corresponds to 11.5 mm (2*5.75 mm). For the mmW antenna operation, the third antenna element 510 can be active in 0.53λ₀ at 28 GHz, which corresponds to 5.75 mm. With this design, both the cmW antenna and the mmW antenna support dual-polarization (45-degree and 135-degree). The design also allows for cmW antenna operation in a fundamental mode and mmW antenna operation in a second harmonic using different PCB materials, such as a high dielectric constant (ϵr of R03010 (11.2)) for the cmW antenna and a low dielectric constant (ϵr of R04725JXR (2.64)) for the mmW antenna. The same antenna profile could be used for each of the antenna elements. For example, the antenna profile for the antenna elements could be 10 mm×10 mm×5 mm.

As shown in FIG. 5C, a graph shows an analysis on an antenna element with different sized slots 514 in order to function as a dual-band antenna. The graph shows the first and second harmonics or peaks of the lines. For a conventional antenna, the second and subsequent peaks would be very weak (low) if visible at all. Because slot 514 has been added to the antenna element, the second peak is higher or stronger and more noticeable. Changing the slot size changes the performance of the antenna element. The graph shows three different slot sizes and the corresponding analysis. The slot size can be selected based on the peaks conforming best with the desired frequency ranges. In the illustrative example, a slot size of 0.4 mm provides the best peak values for the 13 GHz frequency range and the 28 GHz frequency range.

As shown in FIGS. 5D-5G, the frequencies are selected for the 13 GHz frequency range and the 28 GHz frequency range. The performance is similar between the cmW antenna and the mmW antenna allowing for the dual-band operation. A single shared array of both FR2 and FR3 elements, which assumes that the FR3 antenna is capable of high gain at 28 GHz. If the harmonic response is low, the FR2 antenna elements can operate with the FR3 antenna deactivated, resulting in severe grating-lobe and side-lobe issues. Therefore, the frequency and gain of harmonic signal is to be optimized without degrading the fundamental signal. Traditional antenna arrays suppress the harmonic to focus on the fundamental frequency because harmonic signals are considered as noise for most applications. As the harmonic fields originate from higher mode of antenna configuration, they are sensitive to mutual coupling of nearby elements.

Although FIGS. 5A through 5G illustrate an example antenna array 500, various changes may be made to FIGS. 5A through 5G. For example, the number and placement of various components of the antenna array 500 can vary as needed or desired. In addition, the antenna array 500 may be used in any other suitable telecommunications process and is not limited to the specific processes described above.

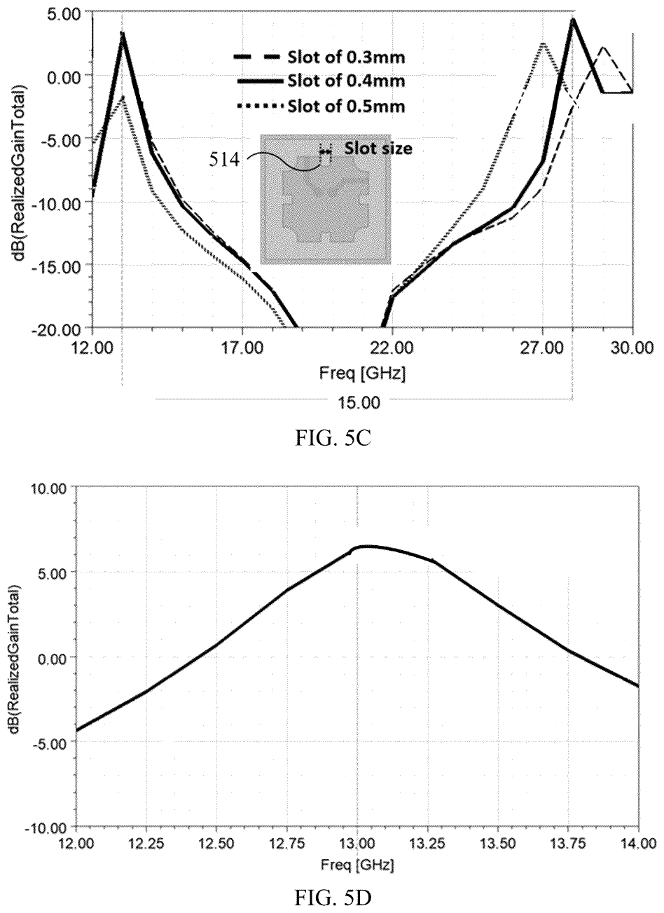

FIG. 6 illustrates an example flowchart 600 of a design of the antenna array in accordance with this disclosure. For ease of explanation, the flowchart 600 of FIG. 6 is described as being performed using the electronic device 401 of FIG. 4. However, the flowchart 600 may be used with any other suitable system and any other suitable electronic device.

As shown in FIG. 6, a massive MIMO system can be designed in step 602. The massive MIMO can include an antenna array of first, second, and third antenna elements.

A theoretical analysis of unit-cells can be performed for the antenna array at step 604. The theoretical analysis of a unit-cell can be performed to determine different measurements of unit-cells to perform communication in a MIMO antenna. Different measurements can be analyzed for determining optimal dimensions.

A circuit analysis of unit-cells can be performed for the antenna array at step 606. A representative circuit can be provided for the unit-cell based on the dimensions determined in the theoretical analysis. The circuit analysis can provide experimental results to confirm the results of the theoretical analysis.

A numerical model of a unit-cell of the MIMO antenna array 500 can be performed at step 608. Based on assumptions of ideal environment without considerations of specific array configurations, numerical methods can be used to analyze electromagnetic fields of each port-to-port coupling.

The 13-GHz parameters can be optimized for the antenna array in step 610. The results of the different analysis can be used to determine optimal dimensions for each of the antenna elements in the antenna array. The optimal dimensions can be determined based on specified frequency band and spacing dimensions.

The harmonic frequency parameters can be optimized for the antenna array in step 612. The results of the different analysis can be used to determine optimal dimensions for each of the antenna elements in the antenna array for operating in other frequency ranges based on the harmonics.

The dual band parameters can be optimized for the antenna array in step 614. The results of the different analysis can be used to determine optimal dimensions for each of the antenna elements in the antenna array for dual band functionality.

The two-element array parameters can be optimized for the antenna array in step 616. The results of the different analysis can be used to determine optimal dimensions for each pair of antenna elements in the antenna array.

The 28-GHz parameters can be optimized for the antenna array in step 618. The results of the different analysis can be used to determine optimal dimensions for the antenna elements in the antenna array for operating at the 28-GHz frequency band.

The combined array parameters can be optimized for the antenna array in step 620. The results of the different analysis can be used to determine optimal dimensions for the antenna elements in the antenna array for beamforming.

The antenna design process can be repeated for different embodiments at step 622. The different embodiments can be used in steps 602-620. The results of the different embodiments can also be compared to determine an optimal antenna design.

Although FIG. 6 illustrates one example of a flowchart 600 of a design of the antenna array, various changes may be made to FIG. 6. For example, while shown as a series of steps, various steps in FIG. 6 may overlap, occur in parallel, or occur any number of times.

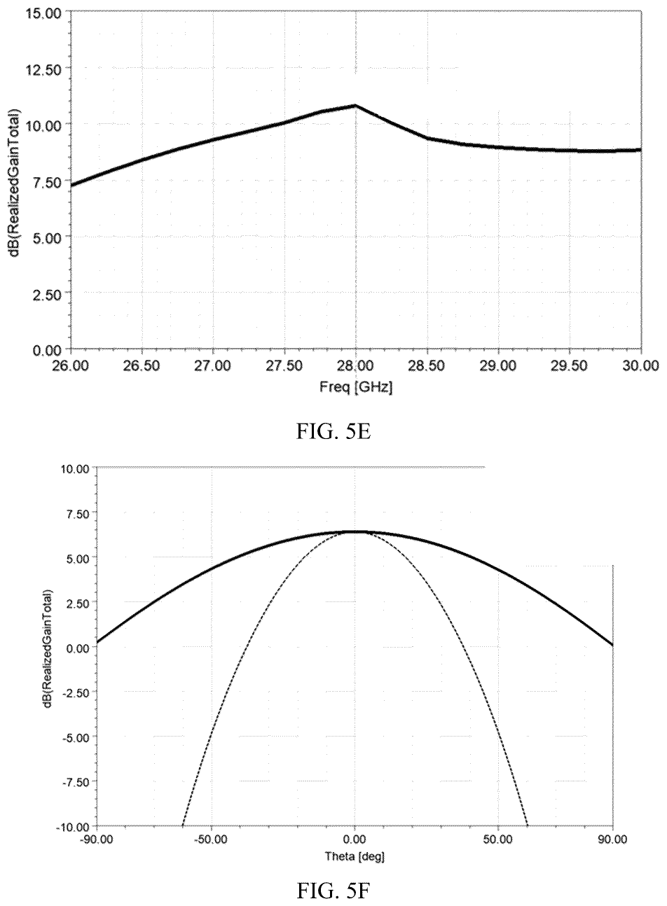

FIGS. 7A through 7D illustrate an example antenna array 700 in accordance with this disclosure. The embodiments of the antenna array 700 illustrated in FIGS. 7A through 7D are for illustration only. FIGS. 7A through 7D do not limit the scope of this disclosure to any particular implementation of an electronic device.

As shown in FIGS. 7A through 7D, compared with a combined array of both FR2 and FR3 antennas, antenna array 700 can utilize five antenna elements 702. The antenna elements 702 can be the same as first and second antenna elements 502 and 506. Each antenna elements 702 is capable of dual band operation via second harmonic optimization. Hence a simplified array employs five same elements 702 to support both the FR2 and FR3 bands. Instead of two types of materials, an antenna array 700 of five antenna elements 702 facilitates an easy fabrication process and results in a low cost. Based on an FR2 antenna configuration, five FR2 elements can be located with half-wavelength separation. As the antenna elements 702 utilize the same element spacing, the antenna elements 702 can be directly located in the same location of FR2 antennas with capability of dual bands. FIG. 7B through 7D present the realized gain of cmW and mmW operation, showing that the combined array obtains 7.27 dB gain at 13 GHz and 11.8 dB gain at 28 GHz.

Although FIGS. 7A through 7D illustrate an example antenna array 700, various changes may be made to FIGS. 7A through 7D. For example, the number and placement of various components of the antenna array 700 can vary as needed or desired. In addition, the antenna array 700 may be used in any other suitable telecommunications process and is not limited to the specific processes described above.

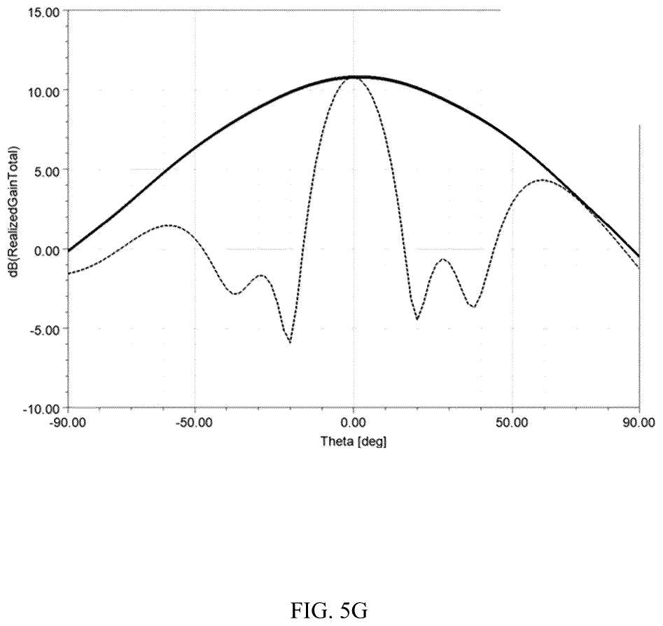

FIG. 8 illustrates an example antenna array 800 in accordance with this disclosure. The embodiment of the antenna array 800 illustrated in FIG. 8 is for illustration only. FIG. 8 does not limit the scope of this disclosure to any particular implementation of an electronic device.

As shown in FIG. 8, antenna array 800 has a different placement of FR2 antenna elements and FR3 antenna elements from the antenna array 500. For example, antenna array 800 can implement three FR3 antenna elements 802 and two FR2 antenna elements 804. Similar to the antenna array 500, antenna array 800 utilizes the relationship of FR2/FR3, resulting in the cmW operation of three antennas and mmW operation of two antennas.

Although FIG. 8 illustrates an example antenna array 800, various changes may be made to FIG. 8. For example, the number and placement of various components of the antenna array 800 can vary as needed or desired. In addition, the antenna array 800 may be used in any other suitable telecommunications process and is not limited to the specific processes described above.

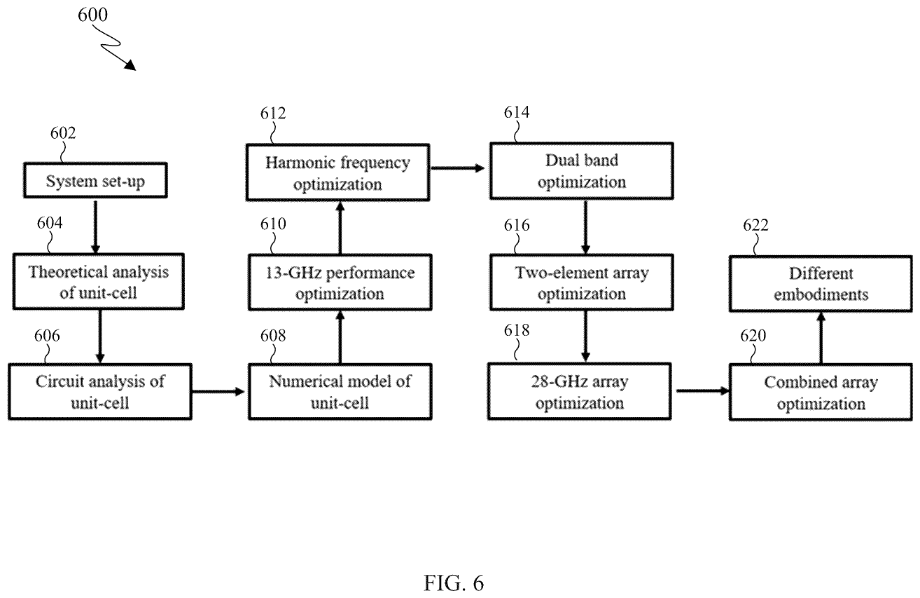

FIG. 9 illustrates an example antenna array 900 in accordance with this disclosure. The embodiment of the antenna array 900 illustrated in FIG. 9 is for illustration only. FIG. 9 does not limit the scope of this disclosure to any particular implementation of an electronic device.

As shown in FIG. 9, example antenna array 900 incorporates a dielectric director 902 for use with the FR3 antennas. Optimizing the harmonic signal with suitable frequency and high gain can be challenging. As the harmonic fields originate from higher modes of antenna configurations, sensitivity to mutual coupling of nearby elements increases. Use of dielectric director 902 can improve the gain of harmonic fields, which also helps to align the peak gain direction at the boresight, by suppressing the mutual coupling.

Although FIG. 9 illustrates an example antenna array 900, various changes may be made to FIG. 9. For example, the number and placement of various components of the antenna array 900 can vary as needed or desired. In addition, the antenna array 900 may be used in any other suitable telecommunications process and is not limited to the specific processes described above.

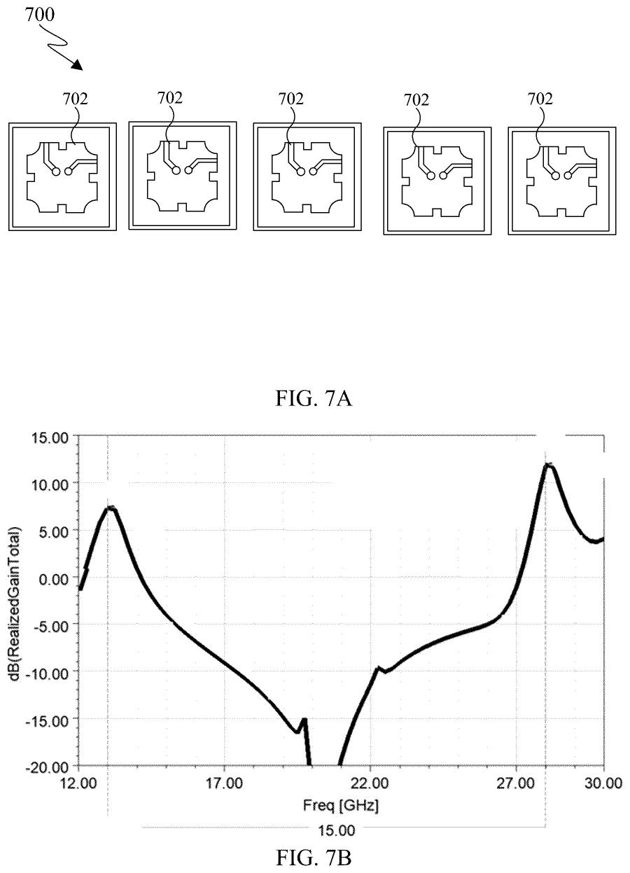

FIG. 10 illustrates an example antenna array module 1000 in accordance with this disclosure. The embodiment of the antenna array module 1000 illustrated in FIG. 10 is for illustration only. FIG. 10 does not limit the scope of this disclosure to any particular implementation of an electronic device.

As shown in FIG. 10, an example antenna array module 1000 can include an antenna PCB 1002, a communication circuit PCB 1004, and communication circuitry 1006. The antenna PCBs 1002 are mounted on the first side of the communication circuit PCB 1004. The communication circuit 1006 can be mounted on the second side of the communication circuit PCB 1004. The second side being opposite to the first side. The communication circuitry 1006 includes a radio frequency integrated circuit (RFIC) 1008, a front end module (FEM) 1010, and a connector 1012. The RFIC 1008 can support mmW antennas, the FEM 1010 can support cmWave antennas, and the connector 1012 can electrically connect the communication circuitry 1006. The communication circuit PCB 1004 could be made up of a different substrate with different permittivity from the antenna PCB 1002.

Although FIG. 10 illustrates an example antenna array module 1000, various changes may be made to FIG. 10. For example, the number and placement of various components of the antenna array module 1000 can vary as needed or desired. In addition, the antenna array module 1000 may be used in any other suitable telecommunications process and is not limited to the specific processes described above.

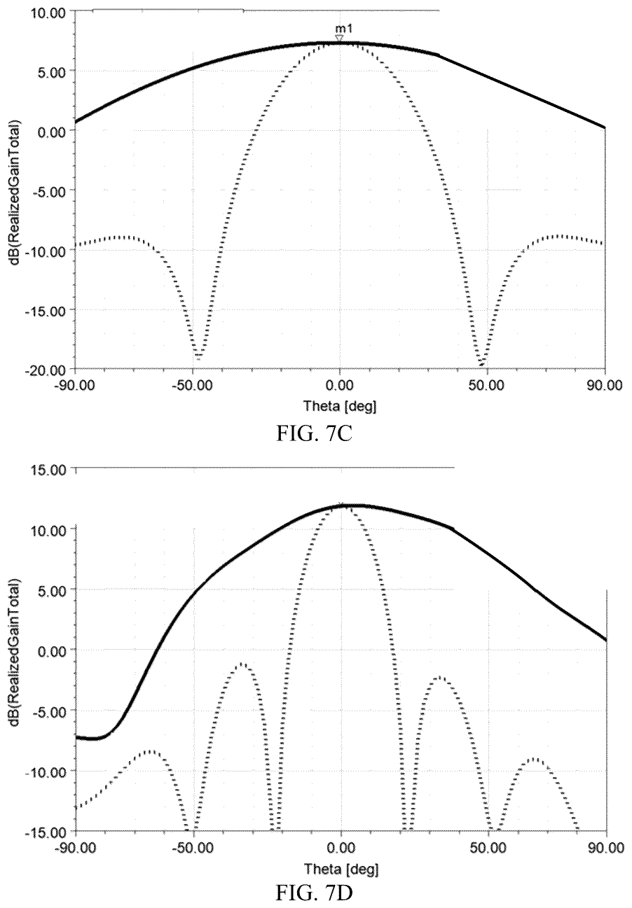

FIGS. 11A and 11B illustrate an example antenna array module 1100 in accordance with this disclosure. The embodiments of the antenna array module 1100 illustrated in FIGS. 11A and 11B are for illustration only. FIGS. 11A and 11B do not limit the scope of this disclosure to any particular implementation of an electronic device.

As shown in FIGS. 11A and 11B, the antenna array module 1100 includes cmW antenna elements 1102, communication circuit PCB 1104, and communication circuitry 1106. The communication circuitry 1106 includes a front end module (FEM) 1110 and a connector 1112. The FEM 1110 can support cmWave antennas and the connector 1112 can electrically connect the communication circuitry 1106. In certain embodiments, mmW antennas are not used. The communication circuit PCB 1104 can be commonly used for the cmW antenna array module 1100 and cmW/mmW antenna arrays to reduce design and manufacturing costs of modules and terminals. A cmW antenna array module 1100 can be made by omitting mmW antenna PCBs and the RFIC, but maintain pads 1120 for the mmW antenna PCBs and the RFIC on the communication circuit PCB 1104. The antenna array module 1100 can include feeding pads 1122, a ground pad, and pad 1120 for fixing a mmW antenna PCB on the first side PCB between cmW antenna elements 1102. The antenna array can also include pads for an RFIC on the second side of the communication circuit PCB 1104. The feeding pads 1122 can be connected to the pads for the RFIC's RF signal (feeding) pads through via lines and signal lines through the communication circuit PCB 1104.

Although FIG. 11 illustrates an example antenna array module 1100, various changes may be made to FIG. 11. For example, the number and placement of various components of the antenna array module 1100 can vary as needed or desired. In addition, the antenna array module 1100 may be used in any other suitable telecommunications process and is not limited to the specific processes described above.

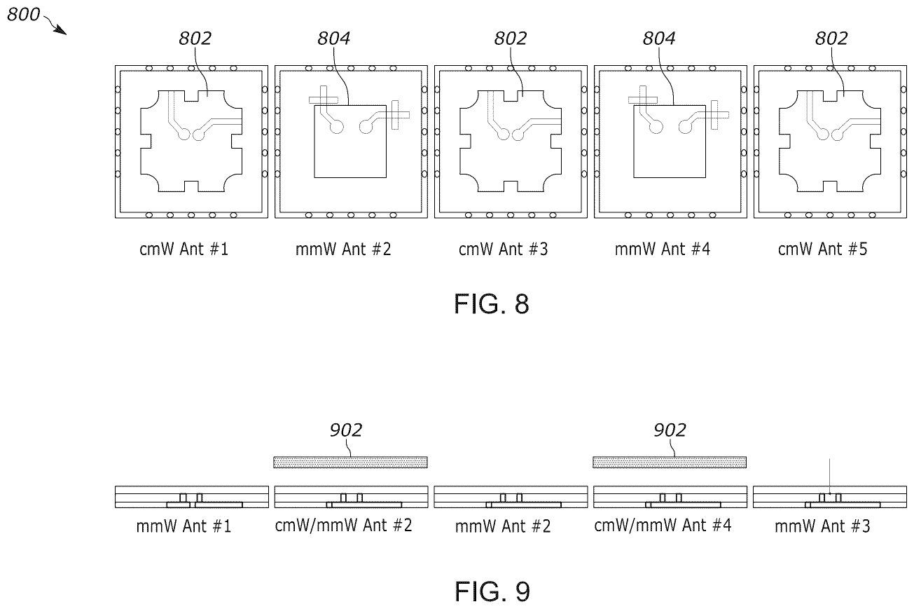

FIG. 12 illustrates an example antenna 1200 with a slitted patch in accordance with this disclosure. The embodiment of the antenna 1200 illustrated in FIG. 12 is for illustration only. FIG. 12 does not limit the scope of this disclosure to any particular implementation of an electronic device.

As shown in FIG. 12, antenna 1200 can include a slit 1202, an inner patch 1204, and an outer patch 1206. The inner patch 1204 can operate for the mmW band and the inner patch 1204 and the outer patch 1206 can jointly operate for the cmW band. The slit 1202 separates the inner patch 1204 from the outer patch 1206. The inner patch 1204 and the outer patch 1206 are electrically connected by coupling in the cmW band. Table 2 shows the bore sight gain of the cmW-mmW antenna 1200 that changes according to a size (or thickness) of the slit 1202 and a size of inner patch 1204. The overall size of the outer patch 1206 remains unchanged based on changing the sizes of the slit 1202 and the inner patch 1204. Tuning can be performed in consideration of the performance trade off shown when adjusting the size of the slit 1202 and the size of the inner patch 1204.

TABLE 2

| Slit size | | | No slit | 0.5 | 0.25 | 0.25 |
|---|---|---|---|---|---|---|
| Inner patch | | | — | 1.35 | 1.4 | 1.2 |
| | cmW freq. | 13.65 | | | 2.095 | |
| | (GHz) | 13.75 | | 1.03 | | 2.2969 |
| | | 14.27 | 2.25 | | | |
| | mmW Freq. | 25.37 | | | 6.162 | |
| | (GHz) | 27.95 | | 5.032 | | |
| | | 28.98 | | | | 5.6975 |
| | | 29.05 | −14.9 | | | |

Although FIG. 12 illustrates an example antenna 1200, various changes may be made to FIG. 12. For example, the number and placement of various components of the antenna 1200 can vary as needed or desired. In addition, the antenna 1200 may be used in any other suitable telecommunications process and is not limited to the specific processes described above.

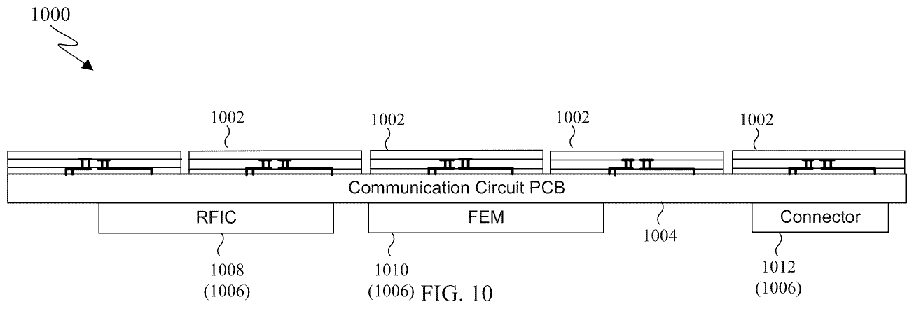

FIG. 13 illustrates an example antenna array 1300 mounted on a metal housing in accordance with this disclosure. The embodiment of the example antenna array 1300 illustrated in FIG. 13 is for illustration only. FIG. 13 does not limit the scope of this disclosure to any particular implementation of an electronic device.

As shown in FIG. 13, the antenna array 1300 is mounted on a housing 1302. The cmW-mmW antenna array 1300 can be mounted on a housing 1302 made of metal. For the cmW antenna, the wavelength is long, so a large opening structure is required and may be filled with a dielectric material.

Although FIG. 13 illustrates an example antenna array 1300, various changes may be made to FIG. 13. For example, the number and placement of various components of the antenna array 1300 can vary as needed or desired. In addition, the antenna array 1300 may be used in any other suitable telecommunications process and is not limited to the specific processes described above.

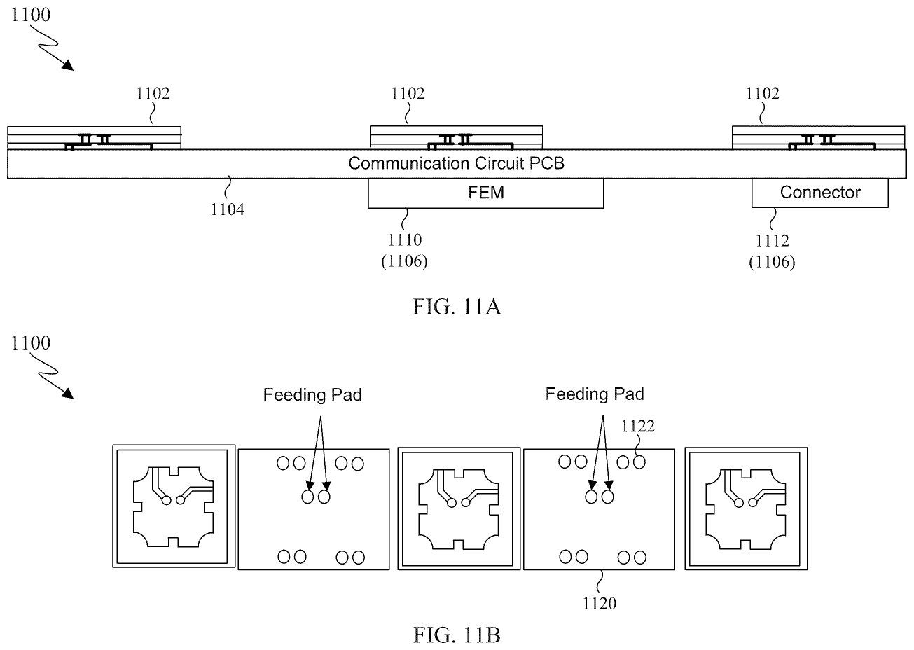

FIG. 14 illustrates an example beamforming pattern 1400 in accordance with this disclosure. The embodiment of the example beamforming pattern 1400 illustrated in FIG. 14 is for illustration only. FIG. 14 does not limit the scope of this disclosure to any particular implementation of an electronic device.

As shown in FIG. 14, the beamforming pattern 1400 has a boresight gain of approximately 6.8 dB. The beamforming pattern 1400 can be used with the antenna array 1300.

Although FIG. 14 illustrates an example beamforming pattern 1400, various changes may be made to FIG. 14. For example, the sizes, shapes, and dimensions of the beamforming pattern 1400 can vary as needed or desired. In addition, the beamforming pattern 1400 may be used in any other suitable telecommunications process and is not limited to the specific processes described above.

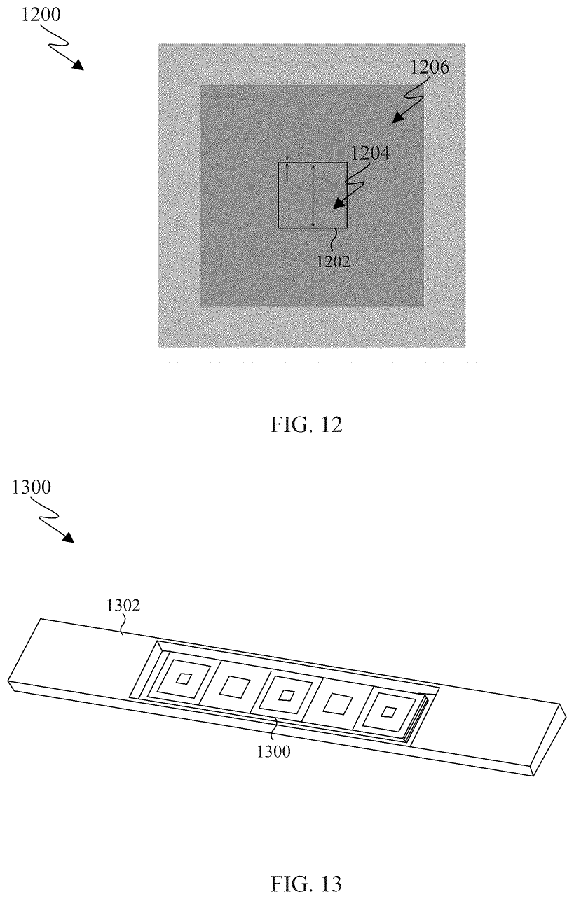

FIGS. 15A and 15B illustrate an example antenna array 1500 in accordance with this disclosure. The embodiments of the example antenna array 1500 illustrated in FIGS. 15A and 15B are for illustration only. FIGS. 15A and 15B do not limit the scope of this disclosure to any particular implementation of an electronic device.

As shown in FIGS. 15A and 15B, an antenna ground 1502 and a communication circuit PCB 1504 are expanded to improve performance of the antenna array 1500. The expanded antenna ground 1502 and communication circuit PCB 1504 can be mounted on a housing 1506.

Although FIGS. 15A and 15B illustrate an example antenna array 1500, various changes may be made to FIGS. 15A and 15B. For example, the number and placement of various components of the antenna array 1500 can vary as needed or desired. In addition, the antenna array 1500 may be used in any other suitable telecommunications process and is not limited to the specific processes described above.

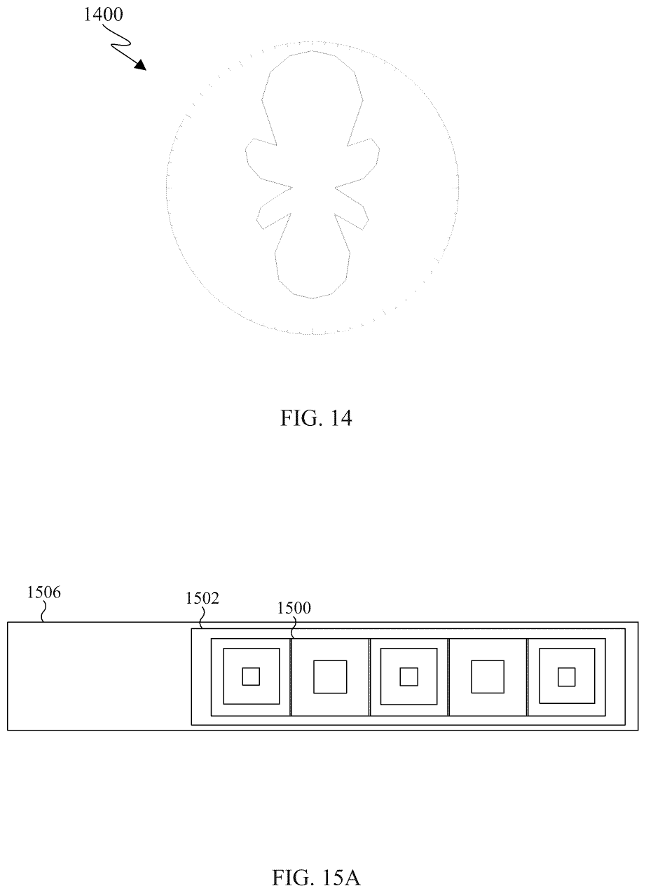

FIGS. 16A and 16B illustrate example beamforming patterns 1600 and 1601 in accordance with this disclosure. The embodiments of the example beamforming patterns 1600 and 1601 illustrated in FIGS. 16A and 16B are for illustration only. FIGS. 16A and 16B do not limit the scope of this disclosure to any particular implementation of an electronic device.

As shown in FIGS. 16A and 16B, beamforming pattern 1600 has a boresight gain of 3 dB and beamforming pattern 1601 has a boresight gain of 4.25 dB. The performance deviates according to whether the antenna ground is expanded. If there is no ground expansion, a radiation pattern can be distorted, and a gain is lower than when ground expansion is used. Table 3 shows the beamforming gain before and after the ground expansion. In the case of the cmW band, the performance can be improved by about 2.2 dB when the ground is expanded. The performance of the mmW does not seem to be a big problem due to a decrease of 0.12 dB.

TABLE 3

| | /wo GND | /w GND |
|---|---|---|
| BF gain | extension | extension |
| cmW | 6.79 | 8.96 |
| mmW | 12.65 | 12.53 |

Although FIGS. 16A and 16B illustrate an example beamforming patterns 1600 and 1601, various changes may be made to FIGS. 16A and 16B. For example, the sizes, shapes, and dimensions of the beamforming patterns 1600 and 1601 can vary as needed or desired. In addition, the beamforming patterns 1600 and 1601 may be used in any other suitable telecommunications process and is not limited to the specific processes described above.

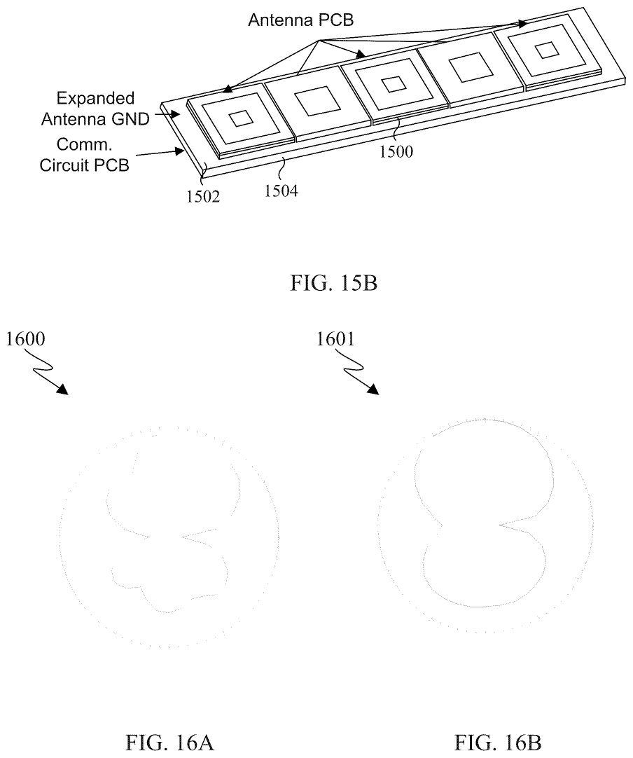

FIG. 17 illustrates an example antenna array 1700 positioned in a recess of a housing 1702 in accordance with this disclosure. The embodiment of the example antenna array 1700 illustrated in FIG. 17 is for illustration only. FIG. 17 does not limit the scope of this disclosure to any particular implementation of an electronic device.

As shown in FIG. 17, the housing 1702 can be raised above the antenna array 1700 or, alternatively, a recess 1704 can be formed for the antenna array 1700. The recess 1704 or raised housing 1702 can accommodate the antenna ground 1706. Table 4 shows a performance of the ground expansion by expanding the circuit PCB and the ground expansion using a metal housing are similar.

TABLE 4

| | Circuit PCB | Metal housing |
|---|---|---|
| BF gain | GND extension | GND expansion |
| cmW | 8.96 | 8.94 |
| mmW | 12.53 | 12.53 |

Although FIG. 17 illustrates an example antenna array 1700, various changes may be made to FIG. 17. For example, the number and placement of various components of the antenna array 1700 can vary as needed or desired. In addition, the antenna array 1700 may be used in any other suitable telecommunications process and is not limited to the specific processes described above.

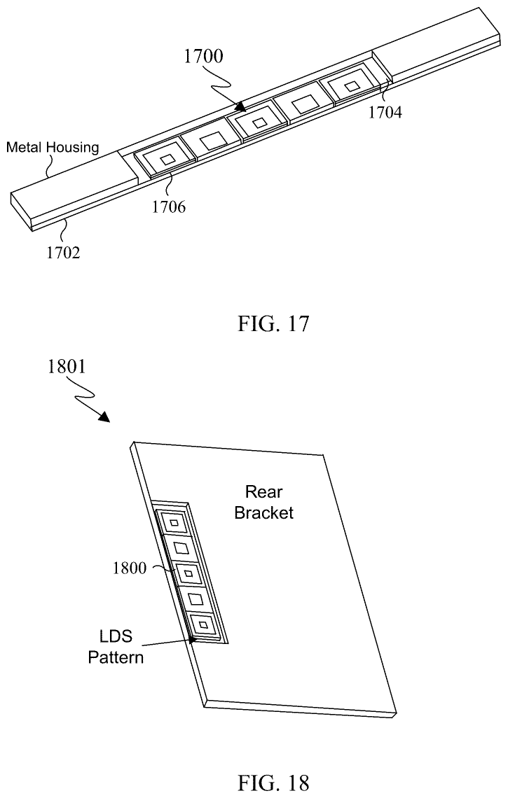

FIG. 18 illustrates an example electronic device 1801 with an antenna array 1800 horizontally mounted in accordance with this disclosure. The embodiment of the example electronic device 1801 illustrated in FIG. 18 is for illustration only. electronic device 1801 does not limit the scope of this disclosure to any particular implementation of an electronic device.

As shown in FIG. 18, an antenna module can be horizontally mounted on a case. For example, the antenna array 1800 can be mounted toward a rear surface of the electronic device 1801. The antenna array part of the rear bracket can be formed according to the ground height of the antenna array. A conductive part can be formed with a laser direct structuring (LDS) pattern to generate an extended ground effect.

Although FIG. 18 illustrates an example electronic device 1801, various changes may be made to FIG. 18. For example, the number and placement of various components of the electronic device 1801 can vary as needed or desired. In addition, the electronic device 1801 may be used in any other suitable telecommunications process and is not limited to the specific processes described above.

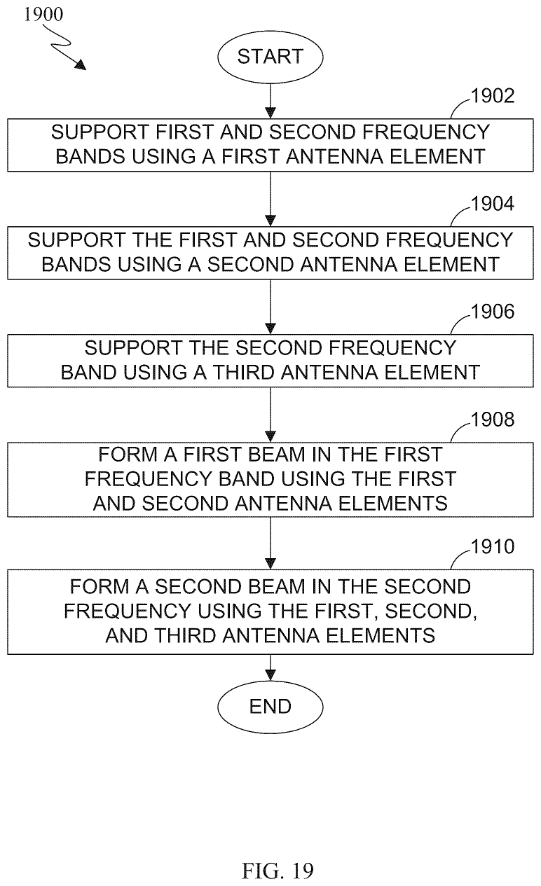

FIG. 19 illustrates an example method 1900 for a dual-polarized dual-band user equipment (UE) antenna array according to this disclosure. For ease of explanation, the method 1900 of FIG. 19 is described as being performed using the electronic device 401 of FIG. 4. However, the method 1900 may be used with any other suitable system and any other suitable electronic device.

As shown in FIG. 19, the electronic device 401 can support first and second frequency bands using a first antenna element at step 1902. The first antenna element can support the first frequency band and the second frequency band, which is higher than the first frequency band. The first antenna element can be included in a first substrate, which includes a first dielectric material having a first dielectric constant. The first antenna element can support a horizontal polarization and a vertical polarization. The first antenna element can have a harmonic resonance of the first frequency band to support the second frequency band. The first antenna element can include a slit configured to support the second frequency band.

The first frequency band can be in an inclusive range from 7 GHz to 24 GHz. The second frequency band can be higher than 24 GHz.

The electronic device 401 can support the first and second frequency bands using a second antenna element at step 1904. The second antenna element can support the first frequency band and the second frequency band. The second antenna element can be included in a second substrate including the first dielectric material. The second antenna element can support a horizontal polarization and a vertical polarization. The second antenna element can have a harmonic resonance of the first frequency band to support the second frequency band. The second antenna element can include a slit configured to support the second frequency band.

The electronic device 401 can support the second frequency using a third antenna element at step 1906. The third antenna element can support the second frequency band. In certain embodiments, the third antenna element does not support the first frequency band. The third antenna element can be included on a third substrate disposed between the first substrate and the second substrate. The third substrate can include a second dielectric material having a second dielectric constant lower than the first dielectric constant. The third antenna element can support a horizontal polarization and a vertical polarization.

The electronic device 401 can include a fourth substrate. The fourth substrate can be disposed under the first substrate, the second substrate, and the third substrate. The first substrate, the second substrate, and the third substrate can be disposed on a first side of the fourth substrate.

The electronic device can also utilize a communication circuit. The communication circuit can be electrically connected with the first antenna element, the second antenna element, and the third antenna element. The communication circuit can be disposed on a second side of the fourth substrate that is opposite to the first side of the fourth substrate.

The electronic device 401 can form a first beam in the first frequency band using the first and second antenna elements at step 1908. The first antenna element and the second antenna element can form the first beam in the first frequency band.

The electronic device 401 can form a second beam in the second frequency using the first, second, and third antenna elements at step 1910. The first antenna element, the second antenna element, and the third antenna element can form the second beam in the second frequency band.

Although FIG. 19 illustrates one example of a method 1900 a dual-polarized dual-band user equipment (UE) antenna array, various changes may be made to FIG. 19. For example, while shown as a series of steps, various steps in FIG. 19 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus comprising:
a first substrate including a first antenna element configured to support a first frequency band and a second frequency band higher than the first frequency band, the first substrate including a first dielectric material having a first dielectric constant;
a second substrate including a second antenna element configured to support the first frequency band and the second frequency band, the second substrate including the first dielectric material; and
a third substrate disposed between the first substrate and the second substrate, and including a third antenna element configured to support the second frequency band, the third substrate including a second dielectric material having a second dielectric constant lower than the first dielectric constant,
wherein the first antenna element and the second antenna element are configured to form a first beam in the first frequency band, and
wherein the first antenna element, the second antenna element, and the third antenna element are configured to form a second beam in the second frequency band.

2. The apparatus of claim 1, wherein:
the first frequency band is between 7 GHz and 24 GHz, and
the second frequency band is higher than 24 GHz.

3. The apparatus of claim 1, further comprising:
a fourth substrate disposed under the first substrate, the second substrate, and the third substrate such that the first substrate, the second substrate, and the third substrate are disposed on a first side of the fourth substrate.

4. The apparatus of claim 3, further comprising:
a communication circuit electrically connected with the first antenna element, the second antenna element, and the third antenna element, and disposed on a second side opposite to the first side of the fourth substrate.

5. The apparatus of claim 1, wherein each of the first antenna element, the second antenna element, and the third antenna element is configured to support a horizontal polarization and a vertical polarization.

6. The apparatus of claim 1, wherein each of the first antenna element and the second antenna element has a harmonic resonance of the first frequency band configured to support the second frequency band.

7. The apparatus of claim 1, wherein each of the first antenna element and the second antenna element has a slit configured to support the second frequency band.

8. An electronic device comprising:
a multiple input multiple output (MIMO) antenna including:
a first substrate including a first antenna element configured to support a first frequency band and a second frequency band higher than the first frequency band, the first substrate and including a first dielectric material having a first dielectric constant;
a second substrate including a second antenna element configured to support the first frequency band and the second frequency band higher than the first frequency band, the second substrate including the first dielectric material; and
a third substrate disposed between the first substrate and the second substrate, and including a third antenna element configured to support the second frequency band, the third substrate including a second dielectric material having a second dielectric constant lower than the first dielectric constant,
transmit (TX) processing circuitry configured to provide signals to the first antenna element, the second antenna elements, and the third antenna elements, and
receive (RX) processing circuitry configured to receive signals from the first antenna element, the second antenna element, and the third antenna element,
wherein the first antenna element and the second antenna element are configured to form a first beam in the first frequency band, and
wherein the first antenna element, the second antenna element, and the third antenna element are configured to form a second beam in the second frequency band.

9. The electronic device of claim 8, wherein:
the first frequency band is between 7 GHz and 24 GHz, and
the second frequency band is higher than 24 GHz.

10. The electronic device of claim 8, further comprising:
a fourth substrate disposed under the first substrate, the second substrate, and the third substrate such that the first substrate, the second substrate, and the third substrate are disposed on a first side of the fourth substrate.

11. The electronic device of claim 10, further comprising:
a communication circuit electrically connected with the first antenna element, the second antenna element, and the third antenna element, and disposed on a second side opposite to the first side of the fourth substrate.

12. The electronic device of claim 8, wherein each of the first antenna element, the second antenna element, and the third antenna element is configured to support a horizontal polarization and a vertical polarization.

13. The electronic device of claim 8, wherein each of the first antenna element and the second antenna element has a harmonic resonance of the first frequency band configured to support the second frequency band.

14. The electronic device of claim 8, wherein each of the first antenna element and the second antenna element has a slit configured to support the second frequency band.

15. A method of using a multiple-input multiple-output (MIMO) antenna comprising:
supporting a first frequency band and a second frequency band higher than the first frequency band using a first antenna element included in a first substrate including a first dielectric material having a first dielectric constant;
supporting the first frequency band and the second frequency band using a second antenna element included in a second substrate including the first dielectric material;
supporting the second frequency band using a third antenna element included in a third substrate disposed between the first substrate and the second substrate, the third substrate including a second dielectric material having a second dielectric constant lower than the first dielectric constant;
forming a first beam in the first frequency band using the first antenna element and the second antenna element; and
forming a second beam in the second frequency band using the first antenna element, the second antenna element, and the third antenna element.

16. The method of claim 15, wherein:
the first frequency band is between 7 GHz and 24 GHz, and
the second frequency band is higher than 24 GHz.

17. The method of claim 15, wherein a fourth substrate is disposed under the first substrate, the second substrate, and the third substrate such that the first substrate, the second substrate, and the third substrate are disposed on a first side of the fourth substrate.

18. The method of claim 17, wherein a communication circuit is electrically connected with the first antenna element, the second antenna element, and the third antenna element, and disposed on a second side opposite to the first side of the fourth substrate.

19. The method of claim 15, further comprising:
supporting, using each of the first antenna element, the second antenna element, and the third antenna element, a horizontal polarization and a vertical polarization.

20. The method of claim 15, further comprising:
supporting the second frequency band using a harmonic resonance of the first frequency band for each of the first antenna element and the second antenna element.
